(19) United States
(12) Patent Application Publication
(10) Pub. No.: US 2011/0159140 A1
(43) Pub. Date: Jun. 30, 2011

(54) MOLD STRUCTURE FOR INJECTION MOLDING

(75) Inventors: Peng He, Taipei (TW); Xiaoping Wu, Taipei (TW); Shih-Hsiung Ho, Taipei (TW)

(73) Assignee: CHENG UEI PRECISION INDUSTRY CO., LTD., Taipei (TW)

(21) Appl. No.: 12/648,267

(22) Filed: Dec. 28, 2009

(51) Int. Cl. B29C 45/27

(52) U.S. Cl. 425/572

(57) ABSTRACT

A mold structure includes a first base which has a first indention area, a first main runner spaced from the first indention area, and a plurality of first subordinate runners communicating with the first indention area and the first main runner, and a second base which has a second indention area corresponding to the first indention area, a second main runner corresponding to the first main runner, and a plurality of second subordinate runners corresponding to the first subordinate runners and communicating with the second indention area and the second main runner. A plurality of first mold cores and corresponding second mold cores is mounted to the first indention area and the second indention area, respectively. The second mold core is engaged with the first mold core to form a mold chamber communicating with a chamber formed by the first indention area and the second indention area.

### BACKGROUND OF THE INVENTION

1. Field of the Invention

The present invention relates to a mold structure, and particularly to a mold structure for injection molding.

2. The Related Art

More and more electronic devices are designed and used in daily life, especially portable electronic devices. The portable electronic devices, which have multiple functions, miniature configuration and high quality, are more and more popular with consumers. At present, most components of the portable electronic devices are manufactured by the injection molding for increasing the production efficiency and reducing the manufacture cost, especially the miniature components. However, the conventional method for molding one miniature component at once wastes the material of the mold, and adds the cost for manufacturing the mold, furthermore, is not greatly successful and effective to increase the production efficiency under mass production of the miniature components.

### SUMMARY OF THE INVENTION

Accordingly, an object of the present invention is to provide a mold structure which is capable of increasing the production efficiency. The mold structure for injection molding includes a first base and a second base coupled with the first base. The first base has at least one first indention area, a first main runner spaced from the first indention area, and a plurality of first subordinate runners communicating with the first indention area and the first main runner. A plurality of first mold cores is mounted to the first indention area. The second base has at least one second indention area corresponding to the first indention area, a second main runner corresponding to the first main runner, and a plurality of second subordinate runners corresponding to the first subordinate runners and communicating with the second indention area and the second main runner. A plurality of second mold cores is mounted to the second indention area, corresponding to the first mold cores. The second mold core is engaged with the first mold core to form a mold chamber communicating with a chamber formed by the first indention area and the second indention area.

As described above, the mold structure has a plurality of first mold cores and the corresponding second mold cores, with a plurality of mold chambers formed therebetween. In the molding process, the material is injected into the first and second main runners, flows through the first and second subordinate runners, the chamber, and fills with the mold chambers. Therefore, the mold structure is capable of producing a plurality of mold products at once, which distinctly increases the production efficiency, and prevents from wasting the material of the mold.

### BRIEF DESCRIPTION OF THE DRAWINGS

The present invention will be apparent to those skilled in the art by reading the following description thereof, with reference to the attached drawings, in which:

FIG. 1 is a cross-sectional view of a mold structure of an embodiment in accordance with the present invention;

FIG. 2 is a partly enlarged view showing an enlarged A portion of FIG. 1;

FIG. 3 is a plan view of a first die of the mold structure shown in FIG. 1; and

FIG. 4 is a plan view of a second die of the mold structure shown in FIG. 1.

### DETAILED DESCRIPTION OF THE EMBODIMENT

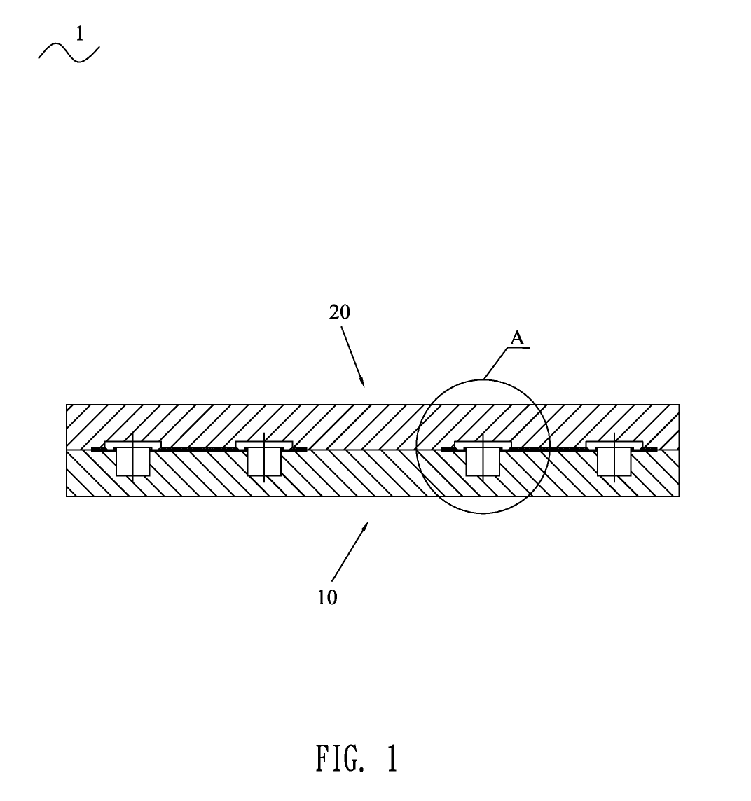

Referring to the drawings in greater detail, and first to FIG. 1, the embodiment of the invention is shown in a mold structure 1 for injection molding. The mold structure 1 comprises a first die 10, and a second die 20 disposed upon the first die 10.

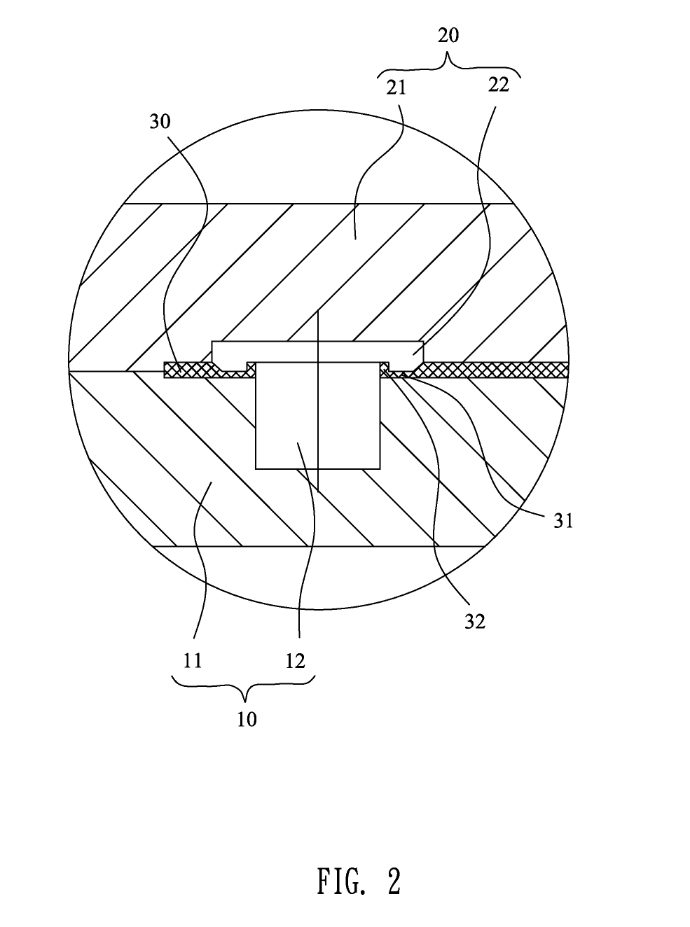

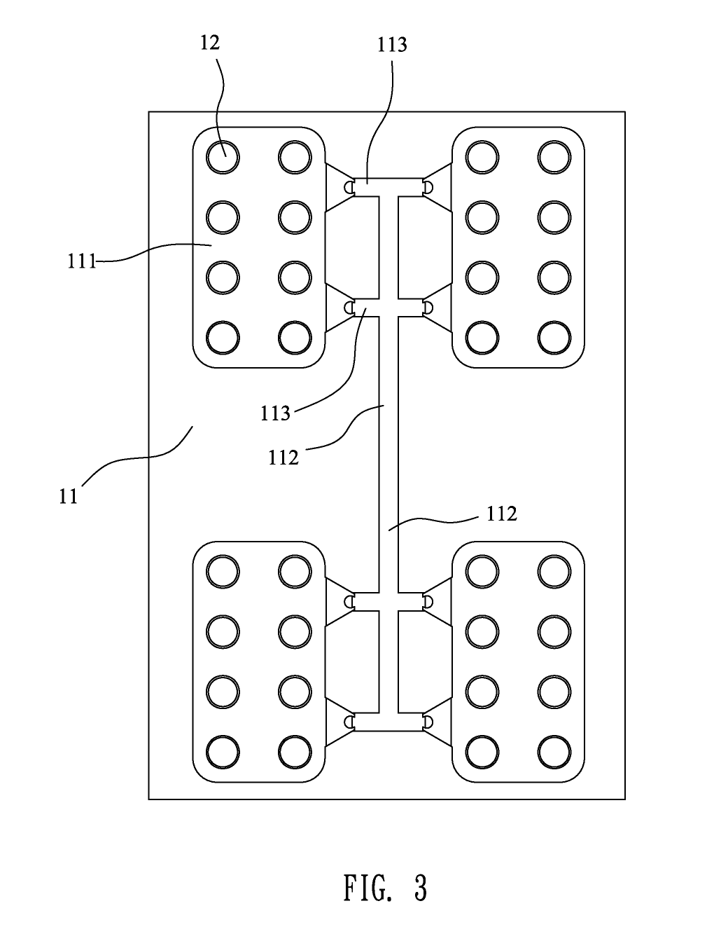

Please refer to FIGS. 2-3, the first die 10 has a rectangular first base 11 of plate shape, and a plurality of first mold cores 12 mounted to the first base 11. The first base 11 has four first indention areas 111 arranged in matrix, and a first main runner 112 located between two abreast rows formed by the first indention areas 111. The first indention area 111 is substantially rectangular. There are eight first mold cores 12 mounted in each first indention area 111, and symmetrically arranged to show two abreast rows which are parallel to an extending direction of the first main runner 112. The first mold core 12 is a cylinder shape and fixed to the first indention area 111, with an upper end thereof exposing outside a bottom of the first indention area 111 with a predetermined distance. The first main runner 112 extends parallel to a length direction of the first indention area 111, and communicates with each first indention area 111 through a first subordinate runner 113. Herein, there are two first subordinate runner 113 formed between the first main runner 112 and each of the first indention areas 111.

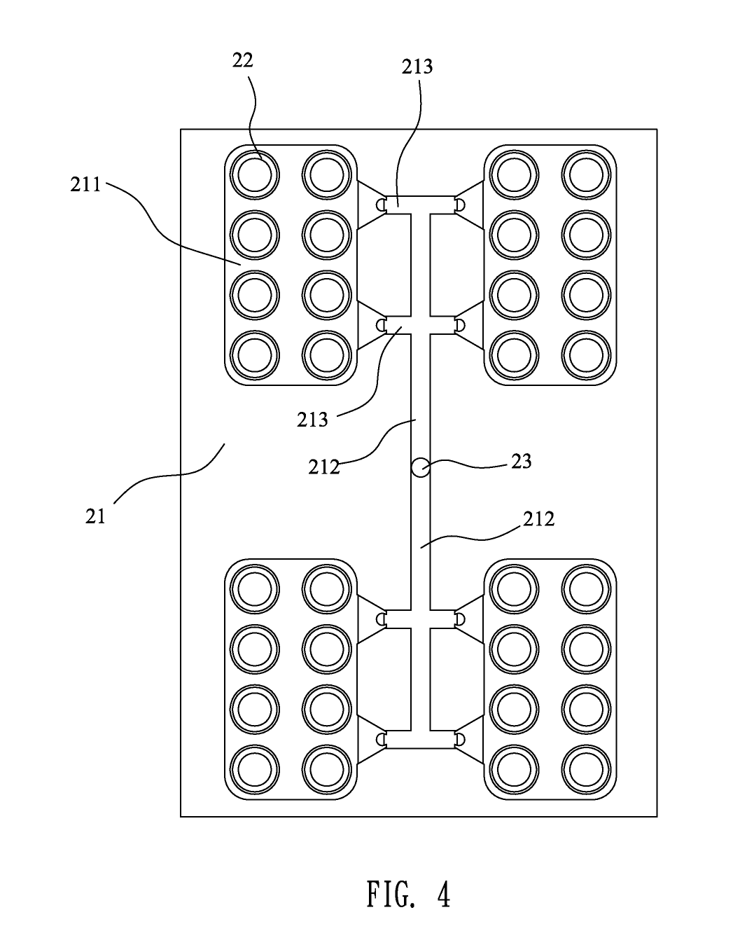

Please refer to FIG. 2, and FIG. 4, the second die 20 is coupled with the first die 10 and has the structure the same as that of the first die 10. The second die 20 has a rectangular second base 21 of plate shape. The second base 21 has four second indention areas 211 arranged in matrix, a second main runner 212 and a plurality of second subordinate runners 213 for communicating with the second main runner 212 and the second indention areas 211. There are eight second mold cores 22 mounted in each second indention area 211, corresponding to the first mold cores 12. Each of the second mold cores 22 is circular cup shape, with an opening facing downwardly, and has an inner diameter larger than an outer diameter of the first mold core 12. In this embodiment, the second base 21 further has a gate 23 formed at a substantially middle portion of the second main runner 212.

Please refer to FIGS. 1-2, when the first die 10 is coupled with the second die 20, the first indention area 111 is coupled with the second indention area 211, forming a chamber 30 therebetween. The first main runner 112 is mated with the second main runner 212 to form a main runner, and the first subordinate runner 113 is mated with the second subordinate runner 213 to form a subordinate runner, for allowing injected material (not shown) in the main runner to flow into the chamber 30. The first mold core 12 and the second mold core 22 are coupled with each other to form a mold chamber 32 therebetween for receiving the injected material. A bottom surface of the second mold core 22 is spaced away from the bottom of the first indention area 111, forming a runner 31. The runner 31 communicates with the mold chamber 32 and the chamber 30 for allowing the injected material in the chamber 30 to flow into the mold chamber 32. The height of the runner 31 is less than that of the mold chamber 32, which is convenient to cut the waste material off the mold product molded in the mold chamber 32.

As described above, the mold structure 1 has a plurality of first mold cores 12 and the corresponding second mold cores 22, with a plurality of mold chambers 32 formed therebetween. The runner 31 communicates with the mold chamber 32 and the chamber 30. A plurality of subordinate runners are designed and formed for communicating the main runner with each chamber 30. In the molding process, the material is injected into the main runner through the gate 23, flows through the subordinate runner, the chamber 30, the runner 31, and fills with the mold chambers 32. Therefore, the mold structure 1 is capable of producing a plurality of mold products at once, which distinctly increases the production efficiency, and prevents from wasting the material of the mold.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A mold structure for injection molding comprising:
a first base having at least one first indention area, a first main runner spaced from the first indention area, and a plurality of first subordinate runners communicating with the first indention area and the first main runner, a plurality of first mold cores being mounted to the first indention area; and
a second base coupled with the first base, the second base having at least one second indention area corresponding to the first indention area, a second main runner corresponding to the first main runner, and a plurality of second subordinate runners corresponding to the first subordinate runners and communicating with the second indention area and the second main runner, a plurality of second mold cores being mounted to the second indention area, corresponding to the first mold cores, wherein the second mold core is engaged with the first mold core to form a mold chamber communicating with a chamber formed by the first indention area and the second indention area.

2. The mold structure as claimed in claim 1, wherein the first base and the second base respectively have four first indention areas and four corresponding second indention areas, arranged in matrix, the first main runner and the corresponding second main runner extend between two abreast rows formed by the first indention areas, and two abreast rows formed by the second indention areas, respectively.

3. The mold structure as claimed in claim 2, wherein each of the first indention areas communicates with the first main runner through two first subordinate runners, each of the second indention areas communicates with the second main runner by two corresponding second subordinate runners.

4. The mold structure as claimed in claim 1, wherein the first mold core is a cylinder shape and has a free end exposing a bottom of the first indention area with a predetermined distance, the second mold core is a cup shape, with an opening facing the first mold core, and has an inner diameter larger than an outer diameter of the first mold core, for receiving the free end of the first mold core to form the mold chamber therebetween.

5. The mold structure as claimed in claim 4, wherein a free end of the second mold core is spaced from the bottom surface of the first indention area to form a runner for communicating with the mold chamber and the chamber.

6. The mold structure as claimed in claim 5, wherein the runner has a height less than that of the mold chamber for being convenient to cut off waste material.
